(19) United States
(12) Patent Application Publication
(10) Pub. No.: US 2019/0269185 A1
(43) Pub. Date: Sep. 5, 2019

(54) Instructive Clothing & Accessories and Method for their Creation and Use

(71) Applicant: Alyse N. Merritt, Land O'Lakes, FL (US)

(72) Inventor: Alyse N. Merritt, Land O'Lakes, FL (US)

(21) Appl. No.: 15/909,604

(22) Filed: Mar. 1, 2018

(51) Int. Cl. A41D 27/08; A47G 33/00; A41D 11/00; A41D 10/00

(52) U.S. Cl. CPC A41D 27/085; A47G 33/00; G09B 19/00; A41D 10/00; A41D 11/00

(57) ABSTRACT

A process for making a educational vestment and accessory including the steps of selecting a story from an educational literary work and choosing an accessory indicative of that literary work. Then printing text and imagery from the story onto an educational vestment and creating a chosen accessory that is manufactured and sold together or separately. A lighting device such as a glow ring is attached to one of the vestments using Velcro fasteners.

### CROSS REFERENCE TO RELATED APPLICATIONS

N/A

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the United States Patent and Trademark Office patent file or records, but otherwise reserves all copyrights whatsoever.

### BACKGROUND

### (1) Field of the Invention

Relating to improvements in the method of the manufacture for various wearable items. More specifically, relating to improvements in the creation of thematic clothing that provides an educational purpose.

Clothing has been utilized in the past to provide warmth, cover extremities to avoid the inappropriate display of the body and for purely decorative purposes. However, clothing has not been used before to foster an educational purpose. Additionally, there are no current mechanisms to target a younger audience that assists parents in teaching moral behavior that can touch the hearts and minds of young people. Further, a bedroom set is a general play area for children and they need to feel welcome and organized. However, the child's room can be a dark and dreary place that does not lend itself to having a great deal of storage space. Also, children do not readily cooperate with parents in maintaining a clean and organized space. Finally, a bedroom set does not lend itself to easily holding the attention of children as they do not have items with which to interact. Thus, there needs to be solutions to overcome this deficiencies.

### BRIEF SUMMARY OF THE INVENTION

In a first aspect, an article of clothing having an imprinted text that is redacted, paraphrased, copied exactly or combinations of the foregoing. The text is from a literary work such as the Bible but can be taken from other literary works.

In a second aspect, an accessory is chosen representative of a story from the Bible or other literary work. It is created using manual or computerized manufacturing techniques.

In another aspect, a process is described having the steps of choosing a story, manipulating the text of the story, choosing an accessory indicative of the story and printing the manipulated text on an article of clothing and creation of the accessory.

In another aspect, a lighting device is included as part of the learning process; the lighting device is optionally attached to the sleeve of the pajama or other part thereof.

### BRIEF DESCRIPTION OF THE SEVERAL VIEWS OF THE DRAWINGS

FIG. 1A, 1B illustrates an embodiment of an article of clothing that demonstrates how imagery and printed the word upon an item creates a religiously oriented educational tool. In particular, FIG. 1A illustrates a unisex article of clothing having religious imagery and a printed passage from the Bible in an embodiment taught herein. FIG. 1B illustrates how a typically feminine article of clothing educates young girls about religion in an embodiment taught herein.

FIG. 2A, 2B, 2C illustrates an embodiment of accessories created in combination with the religiously oriented clothing of FIG. 1. FIG. 2A illustrates a communion chalice, whilst FIG. 2C shows a paten and host utilized as accessories teaching youngsters about their religious beliefs in an embodiment taught herein. FIG. 2B illustrates two tablets of the Ten Commandments teaching youngsters about their religious beliefs in an embodiment taught herein.

FIG. 3A-3B illustrates an embodiment of a process by which a story is selected for printing along with imagery and the creation of accessories. FIG. 3A illustrates a process showing how text is selected from a pre-existing work such as the Bible and the selected and or paraphrased or redacted portion of that text is printed on an article of clothing along with imagery associated with the text in an embodiment taught herein. Additionally, FIG. 3B illustrates a process showing how an accessory is created associated with a selected religious text in an embodiment taught herein.

FIG. 4 illustrates an embodiment of the overall process greatly simplified on how to create an article of clothing and accessory for an educational purpose.

FIG. 5A illustrates an embodiment of an article of clothing that demonstrates how imagery (Jonah and the whale) and printed word upon an item creates a religiously oriented educational tool. FIG. 5B illustrates an embodiment of an article of clothing that demonstrates how imagery (Ark and Animals) and printed word upon an item creates a religiously oriented educational tool. FIG. 5C illustrates an embodiment of an article of clothing that demonstrates how imagery (David, Goliath, Sling, Stones Bracelets) and printed word upon an item creates a religiously oriented educational tool.

FIG. 6A, 6B, 6C illustrates an embodiment of accessories created in combination with the religiously oriented clothing of FIGS. 5A, 5B, 5C. FIG. 6A illustrates a slingshot and 5 smooth stones manufactured as a bracelet from the story of David vs. Goliath manufactured for children's play and learning of biblical accounts for use with FIG. 5C in an embodiment taught herein. FIG. 6B illustrates a whale from the story of Jonah and the whale manufactured for children's play and learning of biblical accounts for use with FIG. 5A in an embodiment taught herein. FIG. 6C illustrates a boat from the story of Noah's Ark manufactured for children's play and learning for use with FIG. 5B in an embodiment taught herein.

FIG. 7A illustrates a lighting device such as a glow in the dark device or a glow ring that has been adapted to be attached to the sleeve of a pajama in an embodiment taught herein. FIG. 7B shows how these are detached from the sleeve in an embodiment taught herein.

FIG. 8 illustrates an alternative embodiment of the pajama tales system.

FIG. 9 illustrates a flowchart of a process utilizing a book, toys and interactive play and recording of the daily activities thereof to assist children in learning a religiously themed subject matter.

FIG. 10A illustrates a blanket utilized in telling the story of a biblical character and storing various items therein in an embodiment taught herein. FIG. 10B illustrates a closeup of a pocket utilized in the blanket of FIG. 10A in an embodiment taught herein. FIG. 10C illustrates various devices utilized in association with the pockets of FIG. 10A, 10B in an embodiment taught herein.

FIG. 11A illustrates how a blanket, comforter or similar device has a close-able figurine on its side having a pocket with the close-able arms open in an embodiment taught herein. FIG. 11B illustrates how a blanket, comforter or similar device has a close-able figurine on its side having a pocket with the close-able arms closed in an embodiment taught herein.

FIG. 12 illustrates a blanket, comforter or similar device having one or moure pouches attachable with velcro in an embodiment taught herein.

FIG. 13 illustrates a group of marsupials having pouches attached via velcro on their backs to the edge of a blanket on a bed; the velcro on the back of the marsupial and on the blanket cooperate together and also facilitate the child's removing them for playing with various different marsupial characters.

FIG. 14 illustrates a bed having various pouches removably attached via velcro on the back of the pouch and corresponding surface of the blanket or alternatively attached to the blanket.

FIG. 15 illustrates a bed having various pouches removably attached via velcro on the back of the pouch and corresponding surface of the blanket or alternatively attached to the blanket.

FIG. 16 presents a bedroom set having various novel features incorporated into the materials thereof in an embodiment herein disclosed.

FIG. 17 present a closeup of the partial moon shaped cloth or plastic containers having open mouth and luminous LED lights protruding out the bottom thereof in an embodiment disclosed herein.

### DETAILED DESCRIPTION OF THE INVENTION

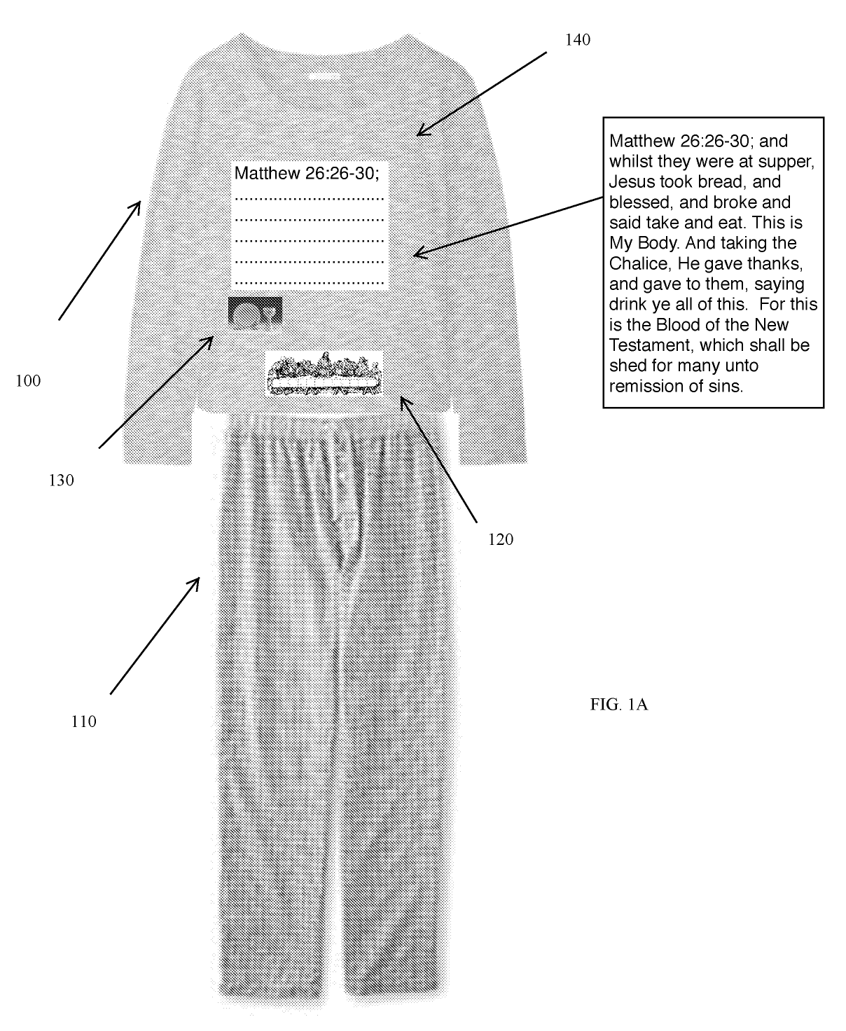

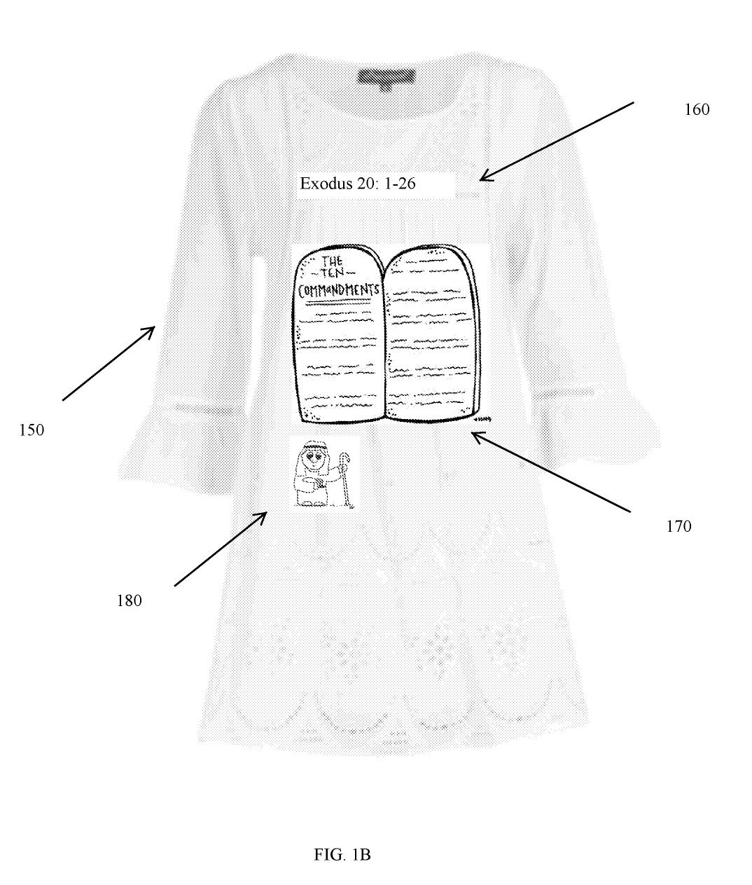

FIG. 1A illustrates an embodiment of an article of clothing 100 that demonstrates how imagery and printed word upon an item creates a religiously oriented educational tool. The clothing can be made from any natural (wool, linen) or manmade (polyester, spandex) cloth, leather or other type of material suitable for this purpose. In particular, FIG. 1A illustrates a unisex articles of clothing 100 and 110 having religious imagery and a printed passage from the Bible.

A top pajama shirt 100 has some text 140 printed on it; in this particular exemplary embodiment, a passage from the New Testament Matthew 26:26-30 is shown dealing with Jesus Christ being the Bread and Blood of the New Testament. A bottom portion 110 shows a typical bottom part of a pajama 110 that can likewise have a printed religious theme (although not shown in the FIG.). Additionally, two items are also printed on the shirt for religious instruction including a communion set 130 and a drawing of the Last Supper 120.

FIG. 1B illustrates how a typically feminine article of clothing educates young girls about religion. A nightgown or smock type of clothing 150 is shown in FIG. 1B that gives another example of the teachings herein. A relevant passage 160 is selected and printed on the article of clothing. Also, a set of two illustrations, in this instance the Two Tablets of the Ten Commandments 170 are printed along with internal text indicative of the passage mentioned previously. Another drawing 180 has also been printed thereon so as to grasp the attention of the user and help him or her understand the import and meaning of the printed text.

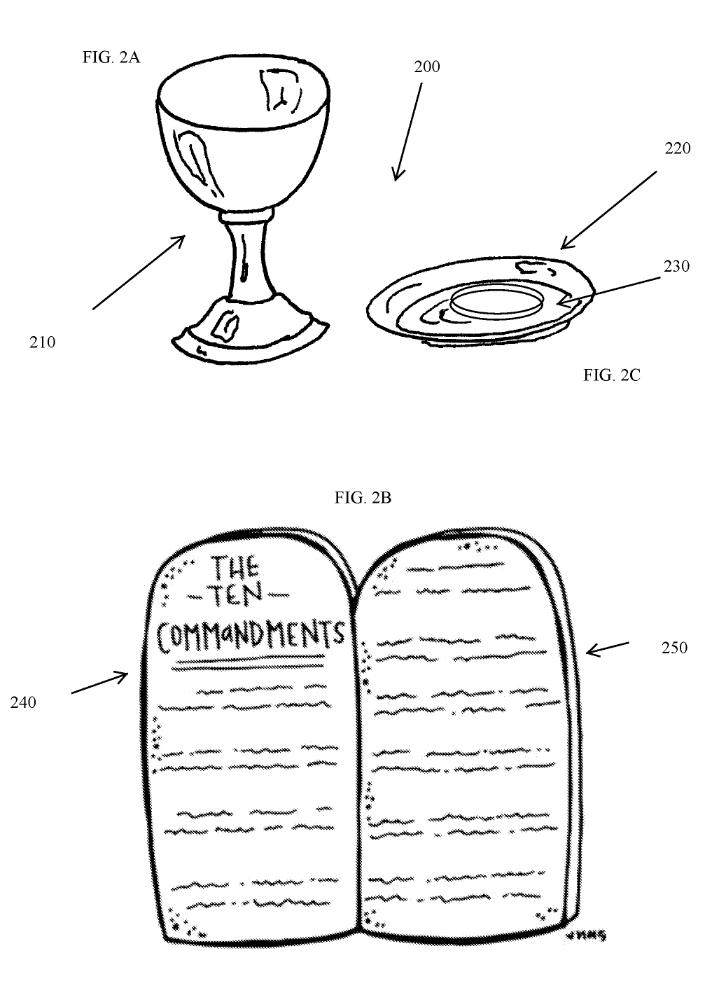

FIG. 2A, 2B, 2C illustrates embodiments of accessories created in combination with the religiously oriented clothing of FIG. 1A, 1B. FIG. 2A illustrates a communion chalice 210, whilst FIG. 2C shows paten 220 and host 230 utilized as accessories to teach people about their religious beliefs in embodiments taught herein. These can be made from any suitable type of plastic, metal, ceramics, glasses, clays or other manufactured or naturally occurring material. FIG. 2B illustrates two tablets 240, 250 of the Ten Commandments teaching youngsters about their religious beliefs. These can be made from any suitable type of plastic, metal or other manufactured or naturally occurring material.

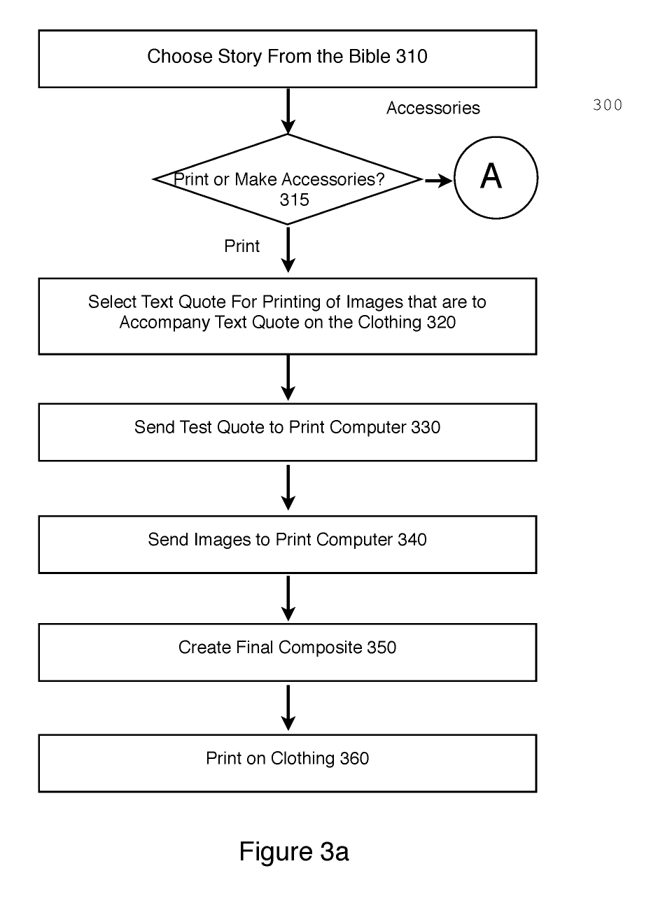

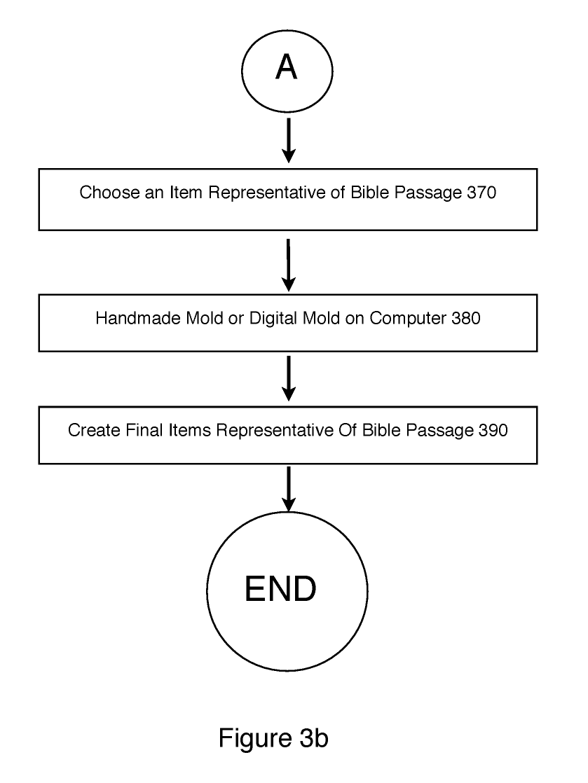

FIG. 3A, 3B illustrates embodiments 300 of a process by which a story is selected for printing along with imagery and the creation of accessories. FIG. 3B illustrates a process showing how text is selected from a pre-existing work such as the Bible and the selected and or paraphrased or redacted portion of that text is printed on an article of clothing along with imagery associated with the text. The process 300 begins with a user choosing 310 a story from a useful educational text such as the Bible. Then a user determines 315 whether to make an accessory or print the selected exact copy, redacted, paraphrased or any combination of the aforementioned text unto an article of clothing for educational purposes. If a user wants to make an accessory then he proceeds to ‘A’ and FIG. 3B.

If not then the user continues to the next step in the process of choosing 320 the selected exact copy, making a redacted, paraphrased or any combination of the aforementioned text. He or she would then send 330 the text to a printer via computer or load it manually into a printing device. If images are to used, he or she would then create the images and send 340 them to a printer via computer or load it manually into a printing device. Next, a final composite of the text and images for printing are created 350 and the text and images are printed 360 on the clothing.

Additionally, FIG. 3B illustrates a process showing how an accessory is created associated with a selected religious text in an embodiment taught herein. A user first chooses 370 an item from a passage that is indicative of it. These can be anything that represents a particular passage such as David's sling and five stones, Aaron's staff, Ark of the Covenant, Burial Shroud, Nativity Cradle and more. Then a handmade mold or digital mold is constructed 380; the digital mold would be made on CAD type computer system. Finally, the items representing a particular passage are manufactured 390 through the use of injection molding, hand molding or similar processes.

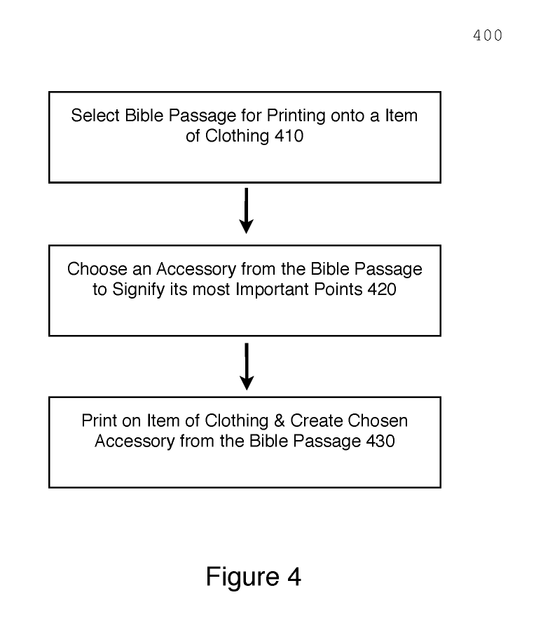

FIG. 4 illustrates an embodiment 400 of the overall process greatly simplified on how to create an article of clothing and accessory for an educational purpose. First an educational passage is selected 410 from a literary work such as the Bible along with imagery to be printed on the clothing for educational purposes. Then an accessory is chosen 420 from the literary work indicating its most important themes. Finally, printing of the text and images along with creation of the accessory is accomplished 430.

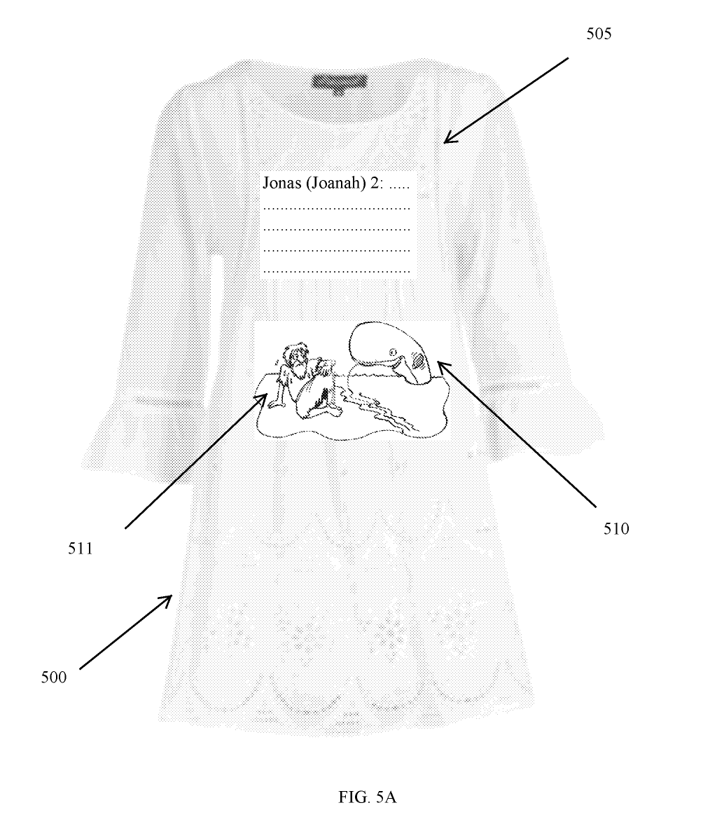

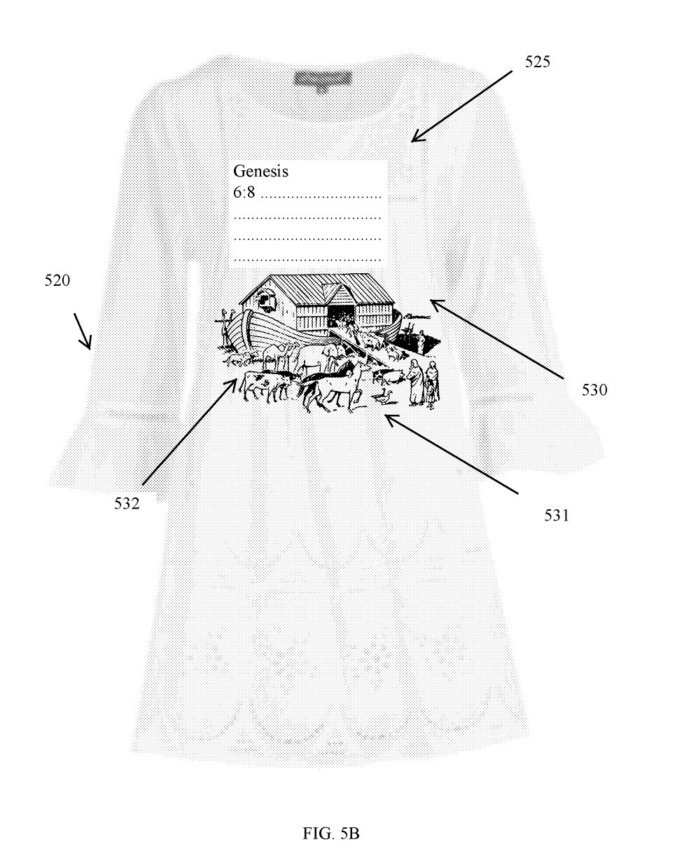

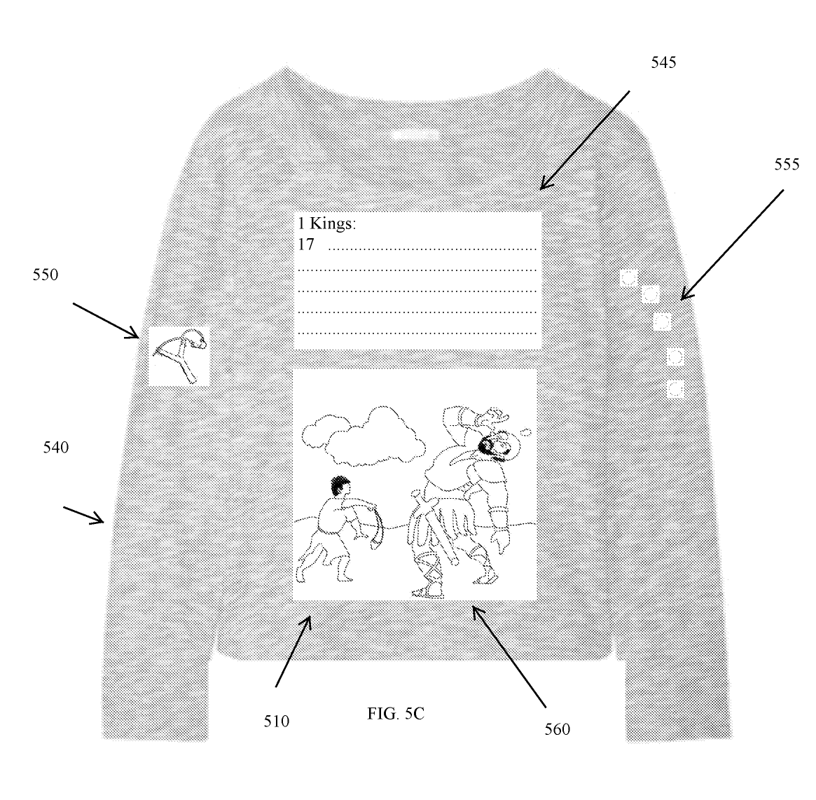

FIG. 5A, 5B, 5C illustrates an embodiment of an article of clothing 500 that demonstrates how imagery and printed word upon an item creates a religiously oriented educational tool. The clothing can be made from any natural (wool, linen) or manmade (polyester, spandex) cloth, leather or other type of material suitable for this purpose. In particular, FIG. 5A illustrates a feminine article of clothing 500 having religious imagery and a printed passage from the Bible. A top region 505 has some text printed on it; in this particular exemplary embodiment, a passage from the Old Testament Jonah 2 is shown dealing with the whale that swallowed the reluctant prophet Jonah who would not help the people of Nineveh until convinced by God. Additionally, two items 510, 511 are also printed on the shirt for religious instruction including a a whale 510 and Jonah 511.

FIG. 5B illustrates an embodiment of how a typically feminine article of clothing educates young girls about religion. A nightgown or smock type of clothing 520 is shown in FIG. 5B that gives another example of the teachings herein. A relevant passage 525 is selected and printed on the article of clothing. Also, a set of three illustrations, in this instance Noah's Ark 530, a giraffe 531, and an elephant 532 are printed along with internal text indicative of the passage mentioned previously. It is desired that the text and imagery will help grasp the attention of the user and help him or her understand the import and meaning of the printed text.

FIG. 5C illustrates an embodiment of how a unisex article of clothing educates youngsters about religion. A top shirt 540 is shown in FIG. 5C that gives another example of the teachings herein. A relevant passage 545 is selected and printed on the article of clothing. Also, a set of four illustrations, in this instance a sling 550 on a shoulder, a bracelet of five smooth stones 555, Goliath 560, and David 570 are printed along with internal text indicative of the passage mentioned previously. It is desired that the text and imagery will help grasp the attention of the user and help him or her understand the import and meaning of the printed text.

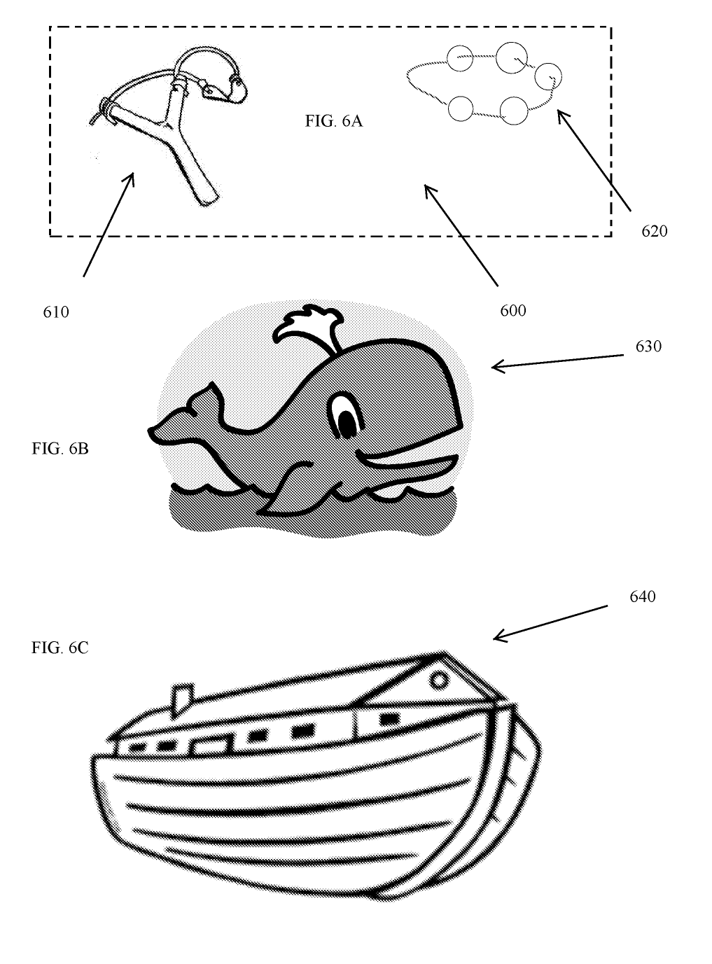

FIG. 6A, 6B, 6C illustrates an embodiment 600 of accessories created in combination with the religiously oriented clothing of FIG. 5A, 5B, 5C. FIG. 6A illustrates a sling 610 and bracelet of five smooth stones 620 utilized as accessories to teach people about David and Goliath in an embodiment taught herein. These can be made from any suitable type of plastic, metal, ceramics, glasses, clays or other manufactured or naturally occurring material. FIG. 6B illustrates a whale 630 utilized as accessories to teach people about their religious beliefs in particular the story of Jonah. This can be made from any suitable type of plastic, metal, ceramics, glasses, clays or other manufactured or naturally occurring material in an embodiment taught herein. FIG. 6C illustrates Noah's ark teaching youngsters about their religious beliefs. This can be made from any suitable type of plastic, metal or other manufactured or naturally occurring material in an embodiment taught herein.

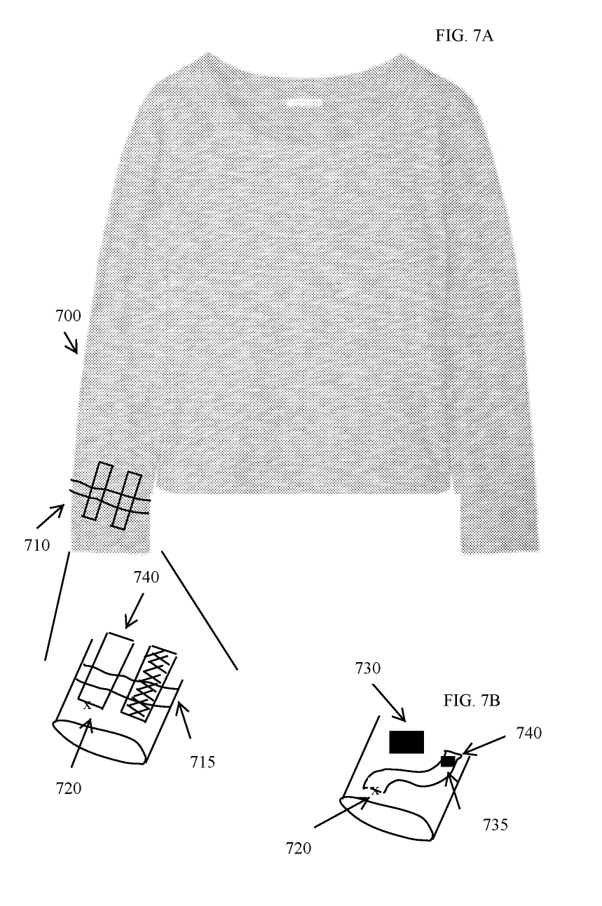

FIG. 7A illustrates a device such as a glow in the dark device or a glow ring 715 that has been adapted to be attached to the sleeve of a pajama. The glow in the dark device 715 can be made from plastics that include the suitable materials having the glow in the dark property for long duration usage or a glow ring that has a short duration utility. A pajama, smock or nightgown sleeve 700 has a lighting device 715 attachment system 710 shown in the FIG. 7A. FIG. 7B shows how these are detached from the sleeve in an embodiment taught herein. Two velcro loop-hook straps 740 are shown attached at one end 720 (XXX in the FIG.) by sewing to the exterior end of a sleeve portion. A hook patch 730 is attached to the sleeve and a corresponding set of loops 735 is attached to the underside end of strap 740. The end where the loops 735 are attached is opposite the sewn end 720 of the strap 740. Thus when the loops 735 are brought into proximity with the hooks 730 they effect a connection between them.

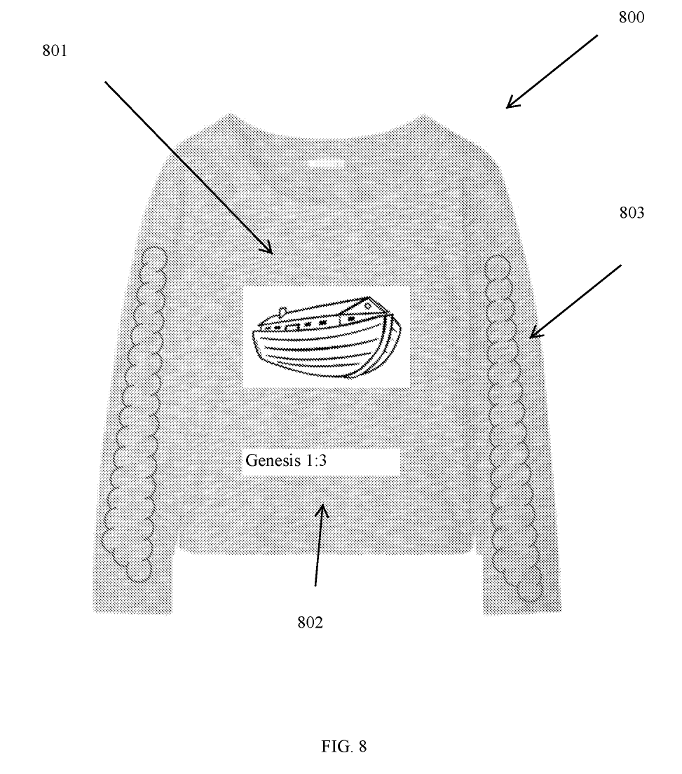

FIG. 8 illustrates an alternative embodiment of the pajama tales system. Here one or both sleeves has a portion, paraphrase or complete text 803 of the relevant passage of the bible. The front portion of the shirt of the pajama has a drawing 801 and a citation of the passage including chapter and verse (s) are printed thereunder.

The embodiments taught herein have shown examples of Biblical passages but they should not be limited to those mentioned herein; rather, any story from the Bible can be utilized in order to practice the embodiments taught herein. Further, whilst pajama type clothing has been described herein, it can be appreciated that the embodiments are applicable to many types of clothing from shorts and t shirts to jeans and long sleeve sweaters, the embodiments are easily adaptable to any type of clothing line. Also, it can be appreciated that steps in the process can be moved and rearranged in other combinations without departing from the spirit and scope of the invention. For example, the process of creating the accessory can occur before the particular text is selected or manipulated through redaction or paraphrasing of the text, afterwards or simultaneously; any of the sequence of steps that can logically changed are variations on the theme taught here.

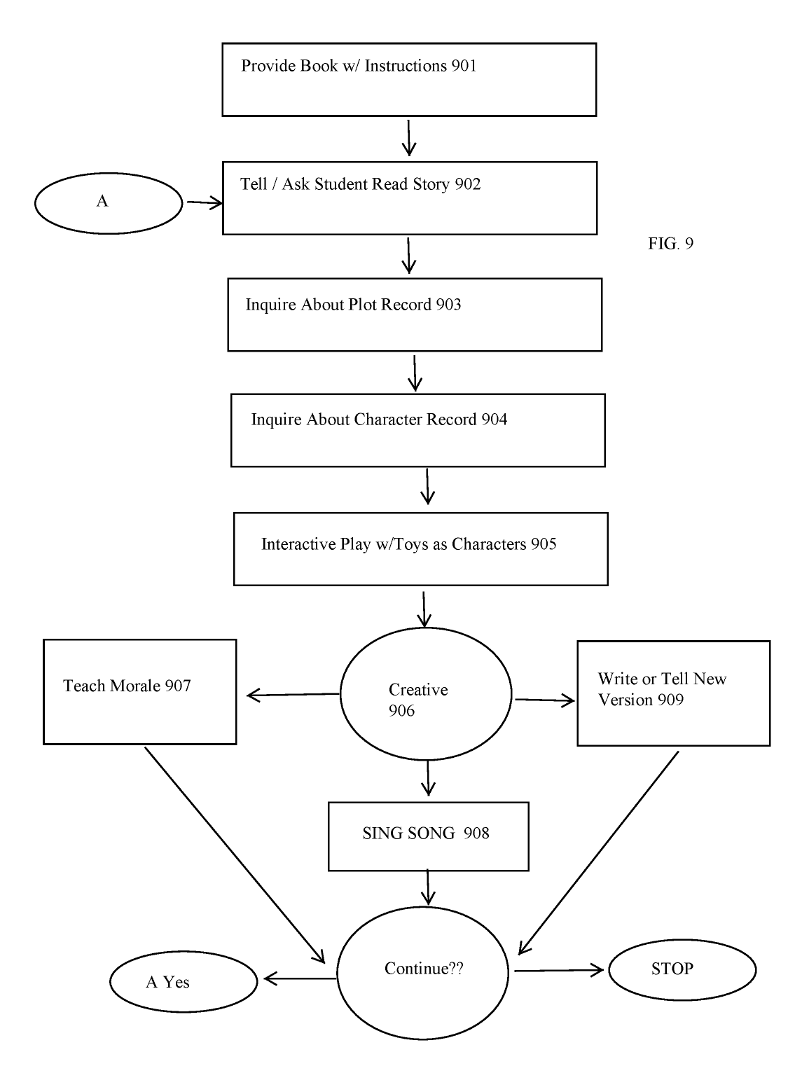

FIG. 9 illustrates a flowchart of a process utilizing a book (or mobile app loaded on cell phone), toys and interactive play and recording of the daily activities thereof to assist children in learning a religiously themed subject matter. First, a book is provided 901 along with associated toys stored in a box along with the book(s), pajamas, or optionally in a blanket with pockets. The process continues with a teacher asking 902 a student to read a story to the group or to the teacher if it is one on one. The teacher continues asking 903 a series of questions about the plot and the children's individual responses are recorded in the teacher's book and the students' books that has a lined place for this. Included in the question list are principle characters 904, action sequences, associated accessories including toys, plot resolution and morale of the story. The children's responses are all recorded and tabulated in the book so that each pupil can interact with each other and help one another. This information is later used when they break up into groups so that they can free style talk about the varying impressions on the story and why they were different.

The teacher/instructor suggests interactive play 905 of willing volunteers or requests different students to play a part along with the toys stored in the optional blanket or in a storage box provided. At this point the students are guided in a creative decision process 906 having three options asking them whether they would like to know about the story morale, sing a song or rewrite the story with the same or new meaning; the students decide what to do or the teacher decides which they will do. The first option is that the teacher educates 907 the class about the morale of the biblical story indicating the various shades and themes of each character as developed through the passages and asks them why this is so?

What happened to make it so? How did it happen? and similar questions to direct and guide them to a full understanding thereof. A second creative option is to sing 908 a prepared song included with each passage in the book The final creative option is that each student is to write or create a new version of the story 909 which is recorded in his or her book and read to the group. From each of these options, a teacher/instructor can decide to stop the process or continue it by proceeding to step 902 again.

The above process is also possible using a mobile app downloaded off the internet, hotspot or wifi. The teacher has an interactive device which transmits the educational steps taught above to each of the students who have a similar app loaded on their own local device. Responses are collected therefrom and sent back to the teacher for review. Interactive buttons and or menus are provided on the app for the transmission of information to and from the teacher and the students and vice versa. The app has an interactive interface showing various features taught by the story including moral, characters, plot, locations, important phrases and similar items thereby permitting students to select and bring up important information at the end of the exercise for study purposes.

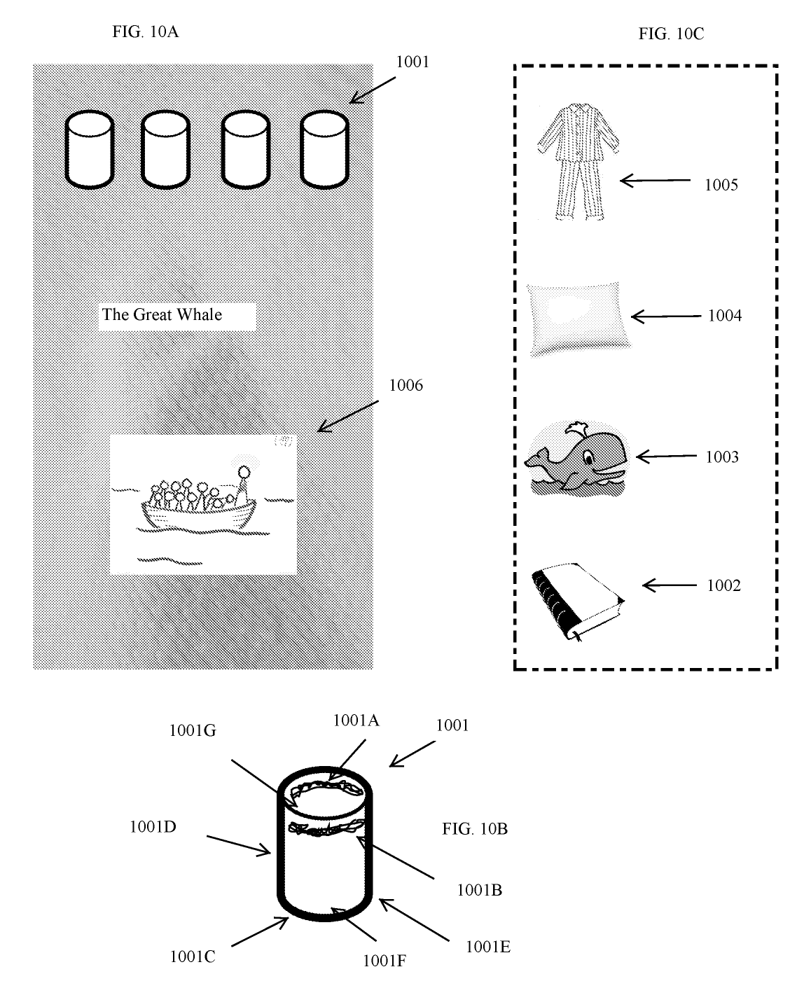

FIG. 10A illustrates a blanket utilized in telling the story of a biblical character and storing various items therein. The blanket 1006 shows an image of a story such as the story of Jonah “The Great Whale” where parts of the story can be printed on the blanket for inspiring interest therein along with keywords associated with the story such as Faith, Fortitude, Obedience, Repentance, Mercy etcetera. A group of pockets 1001 is formed along a top portion of the blanket 1006. A book 1002, a toy 1003, a pillowcase 1004, a pajama 1005 are shown for loading into the pockets of the blanket.

FIG. 10B illustrates a closeup of a pocket utilized in the blanket of FIG. 10A. The pocket 1001 is made from a piece of material 1001F attached to a surface of the blanket where the right side 1001E, left side 1001D and bottom side 1001C of the piece of material 1001F are sewn to the top surface of the blanket 1006. The top portion 1001G of the piece of material 1001F is free, forming a mouth for the pocket and the top surface of the blanket. On the inside surface lip 1001B of the piece of material 1001F is a velcro material affixed thereto with glue, adhesive, or heat treatment. There is a corresponding piece of material 1001A that is attached to the top surface of the blanket 1006 thereby providing a locking mechanism for the pocket 1001.

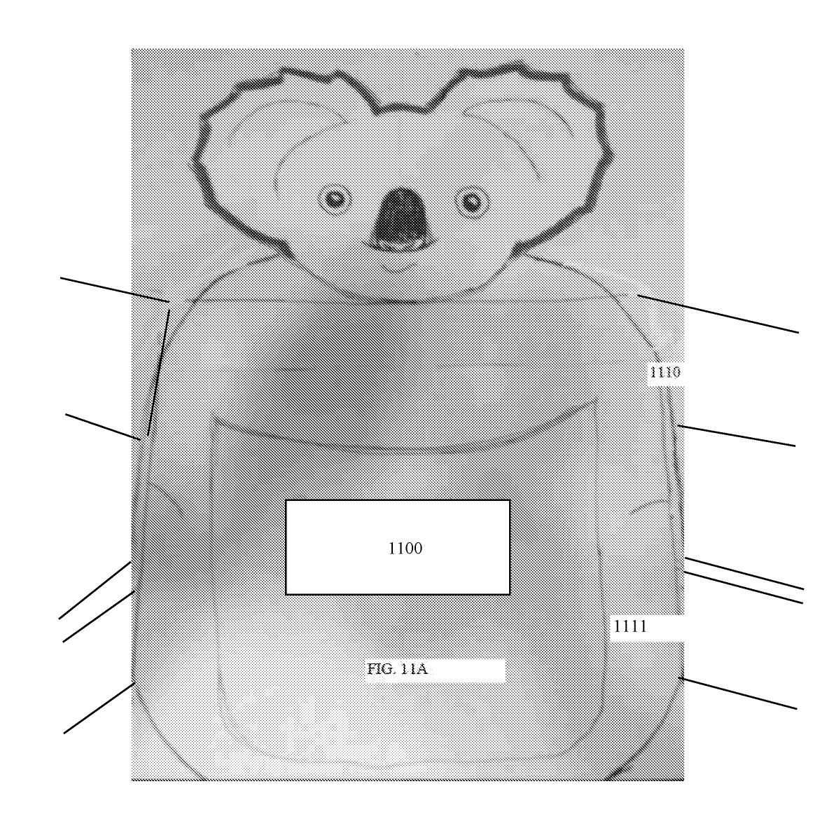

FIG. 11A illustrates how a blanket, comforter or similar device has a close-able figurine on an edge or side of the blanket having a pocket with the close-able arms open in an embodiment taught herein. A marsupial or similar creature figure is sewn at its back into a side of a blanket or comforter (or attached via velcro on back of figure with corresponding velcro on blanket, comforter, sheet and so forth). The marsupial has several arms, legs or appendages 1110-1111 that are normally open for kids play; each of the arms or legs attaches at its respective end to the body of the character (attached on the blanket, sheet, or comforter) and is sewn therein. In the center of the figure is a pocket or pouch 1100 made from a piece of material having four sides with three sides sewn to the blanket and or marsupial figurine (or similar character) and an open side forming the pocket mouth for storage of items therein. Corresponding velcro on the inner lip of the open side and underneath it on the marsupial surface complete the closure thereof. Also, the marsupial has arms 1110 that can be closed about the pocket using velcro (not shown) on the end of each arm (or legs) corresponding with the opposite horizontal arm (or legs) or attached to the exterior surface of the pocket, comforter, blanket, sheet using velcro. FIG. 11B illustrates how a blanket, comforter or similar device has a close-able figurine on its side having a pocket with the close-able arms closed in an embodiment taught herein. Here the velcro attached to arms 1110 at top permit closure between the top two arms with velcro corresponding pieces near an end (paw) of the left top arm and near the end (paw) of the bottom of the right arm. In the bottom set, the legs 1111 have velcro on the bottom of both legs and has corresponding velcro on the body of the figure, pocket, (blanket, sheet, or comforter when character has an opening in its body thereto or is not fully displayed in its full form so that the bed cover, sheet, blanket, comforter is actually a portion of the figure body) as appropriate for closure. An alternative would be that the bottom legs 1111 close like the top arms 1110 one atop another or the top arms close like the bottom legs where they attach to the figure body, blanket, sheet, comforter.

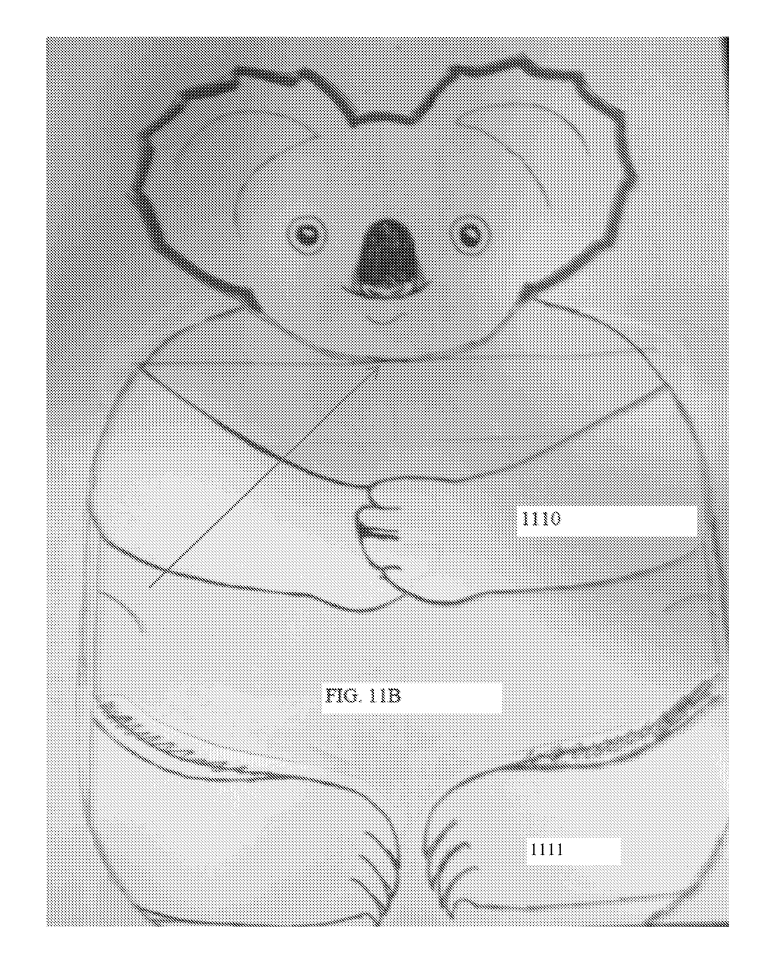

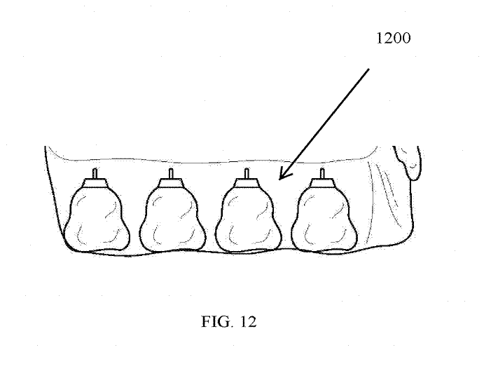

FIG. 12 illustrates a blanket, comforter or similar device having one or more string close-able pouches attachable with velcro in an embodiment taught herein. The pouches 1200 are attachable with velcro with a portion attached on the back thereof and the other piece attached on the blanket with corresponding hooks and loops making the velcro pairing. This facilitates a child removing the pouch and carrying it away from the play area of the blanket comforter or similar device. The pouch is closed by a pull string that closes the mouth of the pouch.

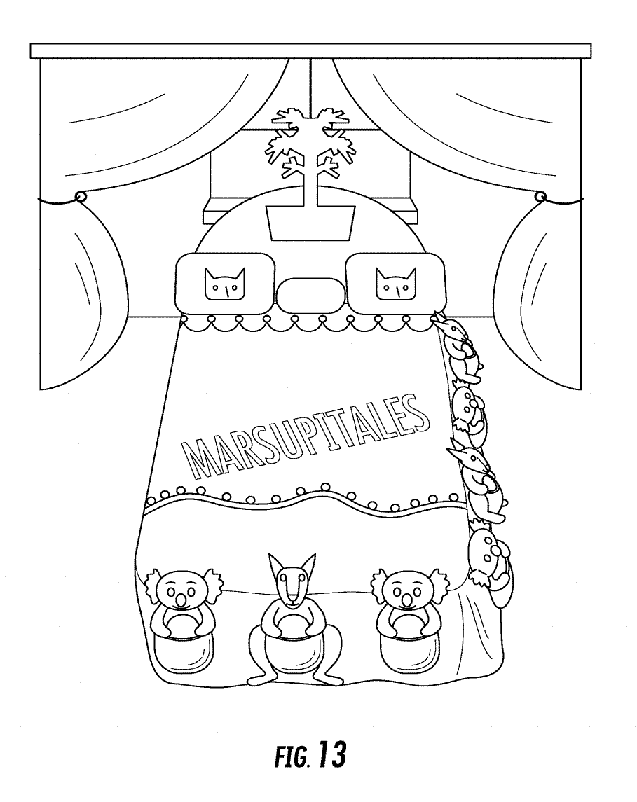

FIG. 13 illustrates a group of marsupials having pouches on their bellies attached via velcro on their backs to the edge of a blanket on a bed; the velcro on the back of the marsupial and on the blanket cooperate together and also facilitate the child's removing them for playing with various different marsupial characters. Alternatively, they are permanently sewn to the edge of blanket for selective storage of items about the bed.

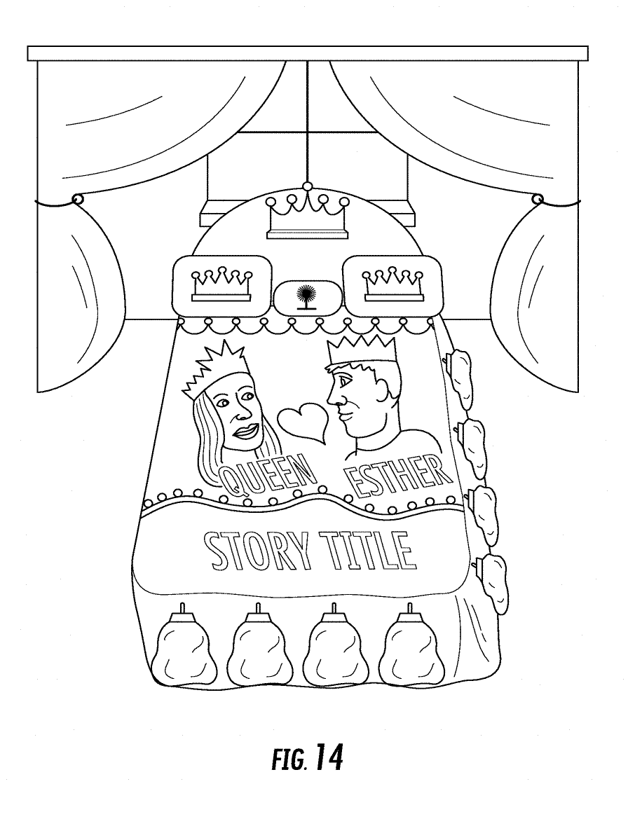

FIG. 14 illustrates a bed having various pouches removably attached via velcro on the back of the pouch and corresponding perimeter surface of the blanket or alternatively attached to the blanket. The figures on the bed represent a particular main character and theme thereon for teaching of the children.

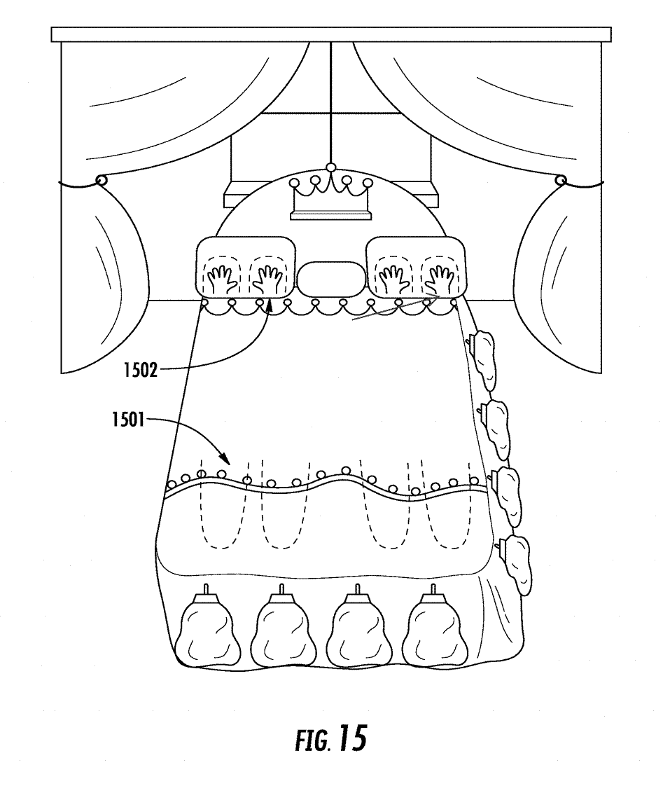

FIG. 15 illustrates a bed having various pouches removably attached via velcro on the back of the pouch and corresponding surface of the blanket or alternatively attached to the blanket. The bed also has a group of foot warmers 1501 attached to the underside of the bed in the shape of an oversized sock for children to insert their feet for comfort. The sock has a typical sock shape (alternatively a simple piece of material sewn to the underside of the blanket on several sides leaving only an open side for sliding in feet) and entry for the foot to slide therein; however, the end of the oversized foot (where the toes are or near there) is sewn to the underside of the blanket. Thus, a child can warm his or her feet by sliding a foot within the oversized warmer 1501. Alternatively, the oversized foot warmer 1501 is attached using a velcro piece attached (sewn) to the foot with a corresponding velcro piece attached (sewn) to the underside of the blanket for selective attachment, removal and re-attachment of the oversized sock foot warmer 1501 to the aforementioned underside. Similarly, the pillowcases 1502 (pillows) has gloves for insertion of a child's hand therein where a portion of the gloves are sewn into the pillowcases; thus the end of the fingers farthest from the palm of the hand are so attached to the pillowcase (or pillow) or alternatively the palm and lower portion of the fingers of the glove, or some portion thereof or some combination thereof. Alternatively, a combo velcro piece attached (sewn) into the glove having a corresponding velcro piece attached (sewn) into the pillow or pillowcase permits the selective removal of the hand gloves. Another alternative has a piece of square or rectangular material sewn on three sides to the pillow case inner surface leaving a fourth side free for insertion of the hands between this side and the pillow case material for warming therein.

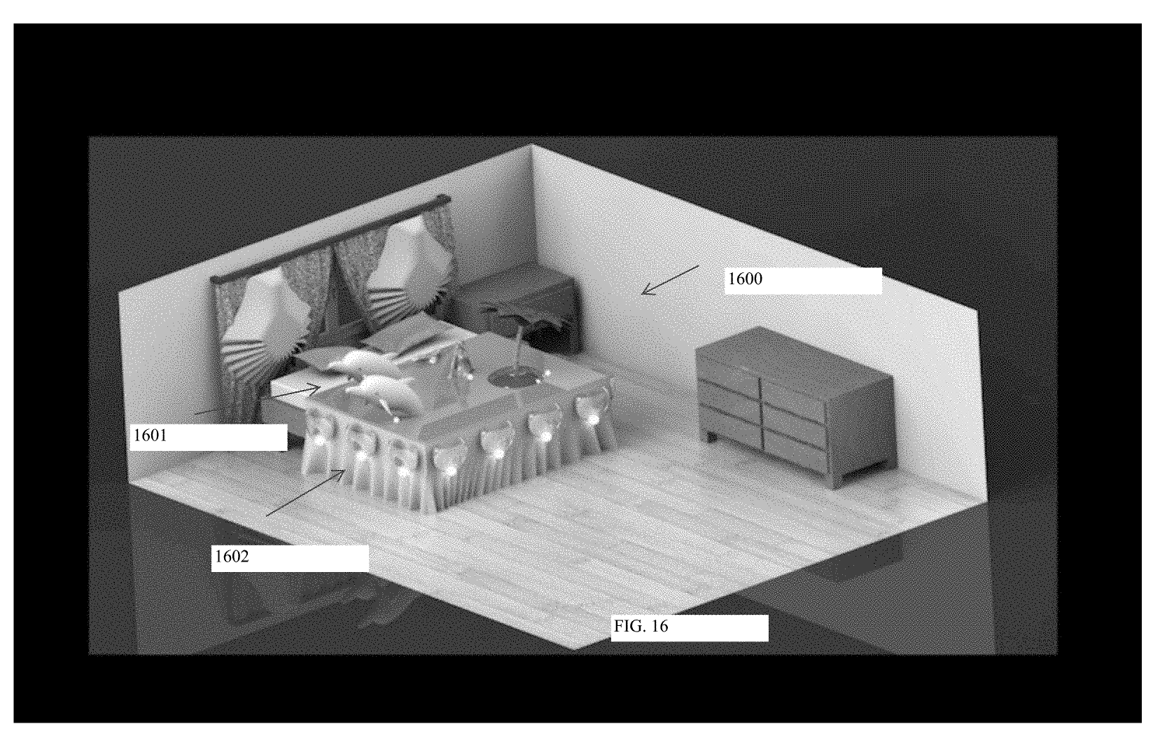

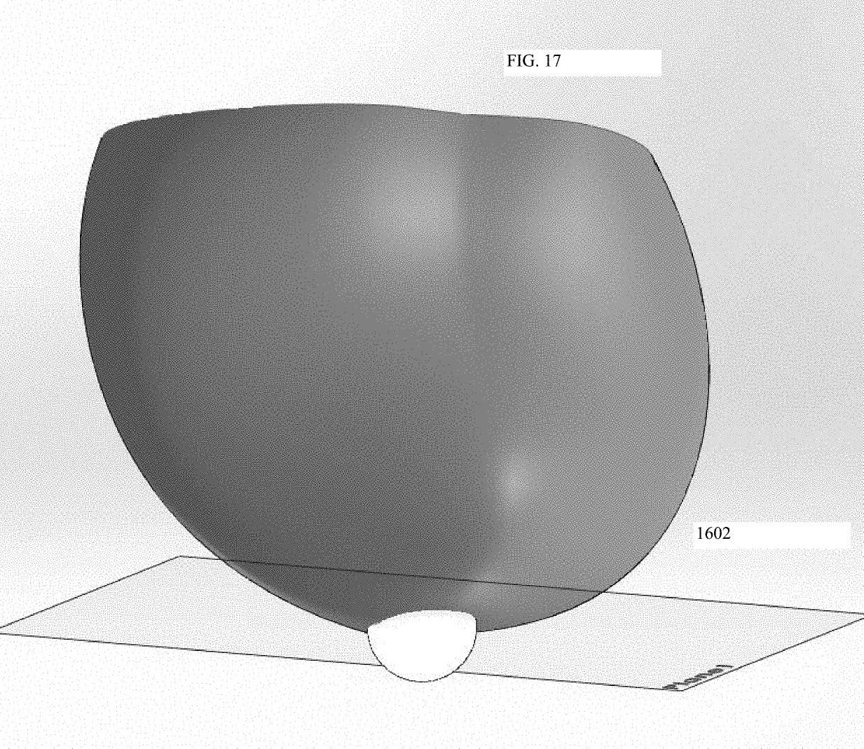

FIG. 16 presents a bedroom set having various novel features incorporated into the materials thereof in an embodiment herein disclosed. In particular, the bedroom set 1600 has various figures 1601 that are attached to the blanket, sheet or comforter on the bed. These figures 1601 take the shape such as a dolphin, a mermaid, a mer tail, a palm tree and so forth. Additionally, there are partial moon shaped cloth or plastic containers 1602 having open mouth and luminous LED lights protruding out the bottom thereof (see FIG. 17). This is facilitated at their underside with velcro material sewn thereto to engage corresponding velcro material atop an appropriate portion of the blanket, comforter or sheet. As an aide in maintaining the figure(s) 1601 upright, each of them optionally has an internal cavity near the location where the velcro connection to the blanket. Sitting within this cavity is a plastic cylinder having an integral wide base; in this optional system, the wide base has the inner surface of the figure adhesive attached thereto. On the external surface of the figure material covering the base, there is sewn velcro material to attach to corresponding material on the blanket sewn therein.

As another alternative, each of the figures optionally has an external cavity near the location where the velcro connection to the blanket; this so that the material of the figure is sewn into a tubular cavity for insertion of a plastic cylinder therein. Sitting within this cavity is a plastic cylinder having an integral wide base; in this optional system, the wide base has velcro material adhesively attached thereto to attach to corresponding material on the blanket sewn thereon.

FIG. 17 present a closeup of the partial moon shaped cloth or plastic containers 1602 having open mouth and luminous LED lights protruding out the bottom thereof in an embodiment disclosed herein. The partial moon shape is either made from plastic or cloth. If it is made from plastic it is attached via velcro adhesively applied to appropriate edges thereof for cooperative engagement with sewn velcro on appropriate surface of the blanket, comforter or sheet. If made from cloth then the cloth is cutout as one piece and either sewn to an appropriate portion of the perimeter of the blanket, comforter or sheet; alternatively, it is attached via velcro adhesively applied (or sewn) to appropriate edges thereof for cooperative engagement with sewn velcro on appropriate surface of the blanket, comforter or sheet. A plurality of these moon shaped containers form a row on one or more sides of the blanket, comforter or sheet where each row can be as little as one container 1602.

Within the confines of the partial moon shape is a totally enclosed housing having a battery compartment and wiring attached to appropriate contacts thereof which wiring exits the housing through a small hole therein and attaches to an LED bulb through another hole at the bottom of the container 1602 through which the LED bulb protrudes. As an additional option, the LED bulb is optionally inserted within an appropriately shaped support member made from clear or colored plastic with flanges on its sides; these are large enough such that it is held within the another hole thereby facilitating the protection of the bulb from the environment and children's activities. Also, there are optional materials that cover the housing so as to separate it from the upper portion of the container having space for toys, clothes and so forth; these cover materials when made from cloth are sewn above the housing internal to the container 1602; or are plastic materials molded integral and internally within the plastic container 1602 or snapped in place using appropriate locking tabs/slots there between. Thus, these cover materials form the bottom of the space for insertion of toys, clothing and so forth.

The invention has thus been described in such clear and precise terms as to enable one of ordinary skill in the art to understand its fundamental principles. Additionally, numerous modifications are possible from the teaching disclosed herein that do not depart from the spirit and scope of the invention and these would still be covered by the claims shown below.

1. A cover comprising:
a blanket;
a first container with a first light attached to the blanket.

2. The cover of claim 1, further comprising: wherein the light is an LED.

3. The cover of claim 1, further comprising:
a second container with a second light attached to the blanket.

4. The cover of claim 1, wherein the first light protrudes out the bottom of the container.

5. The cover of claim 1, wherein the first container is moon shaped.

6. The cover of claim 1, wherein the first container is partial moon shaped.

7. The cover of claim 1, wherein the first container is made from plastic.

8. The cover of claim 1, wherein the first container is made from cloth.

9. The cover of claim 1, further comprising:
a first piece of velcro attached to the first container.

10. The cover of claim 9, further comprising:
a second piece of velcro attached to the blanket for cooperative engagement with the first piece of velcro.

11. The cover of claim 1, further comprising:
a first piece of velcro attached to the blanket.

12. The cover of claim 11, further comprising:
a second piece of velcro attached to the first container for cooperative engagement with the first piece of velcro.

13. The sheet of claim 1, further comprising:
a housing having
a battery compartment;
wiring attached to appropriate contacts thereof and attached to the first light appropriately.

14. The sheet of claim 1, further comprising:
a support member for the first light.

15. A sheet comprising:
a bedroom blanket having
a first container attached to a first side of the bedroom blanket with a first light in the first container forming a first row on the first side of the bedroom blanket.

16. The sheet of claim 15, further comprising:
a first container attached to a second side of the bedroom blanket with a second light in the second container forming a second row on the second side of the bedroom blanket.

17. The sheet of claim 15, wherein the first light comprises an LED.

18. The sheet of claim 15, further comprising:
a housing having
a battery compartment;
wiring attached to appropriate contacts thereof and attached to the first light appropriately.

19. The sheet of claim 15, further comprising:
a support member for the first light.

20. The sheet of claim 15, further comprising:
material separating a portion of the first container from an electronic housing.
